(19) United States
(12) Patent Application Publication
(10) Pub. No.: US 2023/0058676 A1
(43) Pub. Date: Feb. 23, 2023

(54) INTERACTIVE TOYS THAT COMPLY WITH THE MONTESSORI EDUCATIONAL METHOD AND THE SAFETY REQUIREMENTS

(71) Applicant: Monti Kids, Inc., Orinda, CA (US)

(72) Inventors: Stacey Keane, Lake Forest, IL (US); Yuki Kawae, Berkeley, CA (US)

(21) Appl. No.: 17/894,044

(22) Filed: Aug. 23, 2022

Related U.S. Application Data
(60) Provisional application No. 63/236,199, filed on Aug. 23, 2021.
(60) Provisional application No. 63/236,639, filed on Aug. 24, 2021.

(51) Int. Cl. A63H 33/22; B42D 1/00; A63H 5/00; B26B 27/00; E03C 1/04; A47G 1/02

(52) U.S. Cl. CPC A63H 33/22; B42D 1/008; A63H 5/00; B26B 27/00; E03C 1/0404; A47G 1/02

(57) ABSTRACT

A toy is disclosed. The toy includes a two-sided frame. The two-sided frame has a first side configured to hold a set of images and a second side includes an acrylic mirror. The toy further includes a stand configured to hold the two-sided frame. The stand has two notches opposite each other.

### CLAIM OF PRIORITY UNDER 35 U.S.C. § 119

The present application claims priority to U.S. Patent Application Ser. No. 63/236,199 entitled “INTERACTIVE TOYS THAT COMPLY WITH THE MONTESSORI EDUCATIONAL METHOD AND THE SAFETY REQUIREMENTS” filed Aug. 23, 2021, and Provisional Application No. 63/236,639 entitled “SYSTEMS AND METHODS FOR FAUCET EXTENSION” filed Aug. 24, 2021, and assigned to the assignee hereof and hereby expressly incorporated by reference herein.

### TECHNICAL FIELD

Embodiments of the present invention generally relate to toys and other items that may be helpful to children or people with certain disabilities, and more specifically to children's interactive, educational toys that comply with the Montessori method and various safety test requirements as provided by various agencies such as the United States Consumer Product Safety Commission (“CPSC”), American Society for Testing and Materials (“ASTM”), etc. and items for people who may have trouble reaching the water flow in a typical sink.

### BACKGROUND OF THE INVENTION

The Montessori Method of education, developed by Dr. Maria Montessori, is a child-centered educational approach based on scientific observations of children from birth to adulthood. Montessori's education method called for free activity within a “prepared environment,” meaning an educational environment tailored to basic human characteristics, to the specific characteristics of children at different ages, and to the individual personalities of each child. The function of the environment is to help and allow the child to develop independence in all areas according to his or her inner psychological directives. To this end, Montessori's method of education focuses on self-directed activity, hands-on learning, and collaborative play. In addition to offering access to the Montessori materials appropriate to the age of the children, the environment generally exhibits the following characteristics: 1) An arrangement that facilitates movement and activity; 2) Beauty and harmony, cleanliness of environment; 3) Construction in proportion to the child and her/his needs; 4) Limitation of materials, so that only material that supports the child's development is included; and 5) Order.

For children aged 0-3 years, toys, to a large extent, determine the world around them, and are a powerful means of development, upbringing, and education. One major challenge with toys, in general, is keeping children interested in playing with the toy for more than a short period of time. Montessori school toys are designed to help children develop respect for others and the environment, self-esteem and self-confidence, self-discipline, coordination, independence, social skills, emotional growth, and cognitive preparation. To this end, Montessori toys are designed to be interactive, educational, and comply with the characteristics listed above. The Montessori toys are designed in a manner that allows the children to actively use their imagination and learn while playing with the toys.

For children aged 0-3, the toys not only need to comply with the characteristics listed above but also need to be safe for children to use. However, currently, the available Montessori toys fail to do so since they do not conform with the CPSC or ASTM safety requirements. The fact that kids aged 0-3 may get severely injured from toys that are not safe is obvious. For example, if the toys are made using unsafe materials, they may break while the kids are playing with them or the kids may bite the toy and ingest unsafe materials, etc. Such unsafe toys may not just have an effect on the kids' physical health but since toys are such an integral part of such kids' life, especially in a Montessori school setting, the unsafe toys may also erode the kids' trust in themselves and their world; confidence in their emerging abilities; gross motor coordination, fine motor skills, and language skills; and independence in daily tasks.

Accordingly, it is advantageous to have Montessori toys that provide both an interactive, educational environment and also comply with the safety requirements as provided by various agencies.

Additionally, children or people with certain disabilities may have trouble reaching the water flow in a typical sink. For example, small children, e.g., toddlers, may not be tall enough to reach the water flow in a typical sink. In another example, adults in wheelchairs may also have trouble reaching the water flow in a typical sink. In another example, adults having small stature may also have trouble reaching the water flow in a typical sink. Accordingly, it may be advantageous to have a device that may provide an extension to a typical sink. Some such devices use plastic to provide such an extension. However, plastic extenders are not flexible, do not fit as broad a range of faucets, and are not compatible with Montessori values because they are plastic. Accordingly, it may be advantageous to have such a device that is not plastic, is flexible, and can fit a broad range of faucets.

### SUMMARY OF THE INVENTION

Provided herein are embodiments of interactive, educational Montessori toys that comply with the safety requirements as provided by various agencies such as CPSC, ASTM, etc.

According to some embodiments of the present invention, a variety of inventive toys are provided. The toys described below have all been uniquely designed after multiple experimentations in order to comply with both the Montessori educational method and also comply with the safety requirements as provided by various agencies such as CPSC, ASTM, etc.

According to some embodiments of the present invention, one of the toys includes a two-sided frame, the two-sided frame having a first side configured to hold a set of images and a second side includes an acrylic mirror and a stand configured to hold the two-sided frame, the stand having two notches opposite each other.

In an example a book includes a plurality of wooden slats, the wooden slats connected using a pair of elastic strings, an end piece coupled to the wooden slats through the elastic strings; and at least one image on at least one wooden slat of the plurality of wooden slats.

In an example, a toy includes a crocheted ball and a crochet ribbing crocheted into the crocheted ball. The crochet ribbing may provide a texture on the ball.

In an example, a rattle includes a round base including a slot and a pair of glue wells at substantially opposite ends of the slot, a dowel imposed within the slot and coupled to the base at each end of the dowl at each glue well of the pair of glue wells, a ball coupled to the dowl and configured to slide within the slot along the dowel, and a pair of side pieces coupled to the base substantially perpendicular to the base.

In an example, a toy includes a frame, an acrylic mirror, within the frame, a shelf coupled to the frame and substantially perpendicular to the frame, and at least one dowel extending from the frame and substantially perpendicular to the frame. In an example, a shelf includes a wooden backing, a mirror backed by the wooding backing, and a frame, coupled to the wooden backing and configured to hold the mirror. The example shelf includes a shelf, coupled to the wooden backing and extending out from the wooden backing on a same side of the wooden backing as the mirror. At least one support is coupled to the shelf and the wooden backing, and at least one peg is configured for hanging an object. Additionally, edges of the wooden backing are beveled, edges of the shelf are beveled, and edges of the at least one support are beveled.

In an example, a toy chopper includes a wedge that may have an edge from ½ to ¼ the width of a base of the wedge. The edge may be rounded, and the wedge may have grooves on at least one side extending from the edge.

A faucet extender includes a flat material having a first hole configured to receive a faucet, the flat material having a second hole configured to receive the faucet, the flat material having a third hole configured to receive the faucet, the faucet extender configured to form a spout when the second hole and the third hole are installed on the faucet.

A method of installing a faucet extender, includes providing a flat material having a first hole configured to receive a faucet, the flat material having a second hole configured to receive the faucet, the flat material having a third hole configured to receive the faucet, the faucet extender configured to form a spout when the second hole and the third hole are installed on the faucet. The method includes installing the faucet extender on the faucet through the first hole. Additionally, the method includes installing the faucet extender on the faucet through the second hole. The method also includes installing the faucet extender on the faucet through the third hole, the installation through the second hole, and the third hole forming a spout.

This summary and the following detailed description are merely exemplary, illustrative, and explanatory, and are not intended to limit, but to provide further explanation of the invention as claimed. Additional features and advantages of the invention will be set forth in the descriptions that follow, and in part will be apparent from the description, or may be learned by practice of the invention. The objectives and other advantages of the invention will be realized and attained by the structure particularly pointed out in the written description, claims and the appended drawings.

### BRIEF DESCRIPTION OF THE DRAWINGS

The present invention may be better understood by referring to the following figures. The components in the figures are not necessarily to scale. Emphasis instead being placed upon illustrating the principles of the disclosure. In the figures, reference numerals designate corresponding parts throughout the different views.

FIGS. 1-4 are diagrams illustrating a Montessori Newborn Kit toy, and more specifically, illustrating a stand that holds a two-sided frame, according to some embodiments of the present invention.

FIGS. 5-7 are diagrams illustrating a Montessori Newborn Kit toy, and more specifically, illustrating a book with black and white animals

FIGS. 8-11 are diagrams illustrating a Montessori Newborn Kit toy, and more specifically illustrating a ball having a raised portion, according to some embodiments of the present invention.

FIGS. 12-16 are diagrams illustrating a Montessori Newborn Kit toy, and more specifically, illustrating a rattle that may be created for extended play, according to some embodiments of the present invention.

FIGS. 17-18 are diagrams illustrating a Montessori Self-Care Station, and more specifically, illustrating a unique combination of a shelf and mirror made child-sized to hang at a low height, according to some embodiments of the present invention.

FIGS. 19-20 are diagrams illustrating a Montessori Cooking Together Kit toy, and more specifically, illustrating a wood cutter or chopper, according to some embodiments of the present invention.

FIG. 21 is a diagram illustrating a faucet extender, according to some embodiments of the present invention.

FIG. 22 is a diagram illustrating a sink and the sink with an installed faucet extender, according to some embodiments of the present invention.

FIGS. 23A-23B are diagrams illustrating a faucet extender installation, according to some embodiments of the present invention.

FIG. 24 is a diagram illustrating a faucet extender installation on a standard faucet, according to some embodiments of the present invention.

FIG. 25 is a diagram illustrating a faucet extender installation on a gooseneck faucet, according to some embodiments of the present invention.

FIG. 26 is a flow diagram illustrating an example method according to some embodiments of the present invention.

The figures and the following description describe certain embodiments by way of illustration only. One skilled in the art will readily recognize from the following description that alternative embodiments of the structures and methods illustrated herein may be employed without departing from the principles described herein. Reference will now be made in detail to several embodiments, examples of which are illustrated in the accompanying figures. It is noted that wherever practicable similar or like reference numbers may be used in the figures to indicate similar or like functionality.

### DETAILED DESCRIPTION

The following disclosure describes various embodiments of the present invention and method of use in at least one of its preferred, best mode embodiments, which is further defined in detail in the following description. Those having ordinary skill in the art may be able to make alterations and modifications to what is described herein without departing from its spirit and scope. While this invention is susceptible to different embodiments in different forms, there is shown in the drawings and will herein be described in detail a preferred embodiment of the invention with the understanding that the present disclosure is to be considered as an exemplification of the principles of the invention and is not intended to limit the broad aspect of the invention to the embodiment illustrated. All features, elements, components, functions, and steps described with respect to any embodiment provided herein are intended to be freely combinable and substitutable with those from any other embodiment unless otherwise stated. Therefore, it should be understood that what is illustrated is set forth only for the purposes of example and should not be taken as a limitation on the scope of the present invention.

In the following description and in the figures, like elements are identified with like reference numerals. The use of “e.g.,” “etc.,” and “or” indicates non-exclusive alternatives without limitation, unless otherwise noted. The use of “including” or “includes” means “including, but not limited to,” or “includes, but not limited to,” unless otherwise noted.

As used herein, the term “and/or” placed between a first entity and a second entity means one of (1) the first entity, (2) the second entity, and (3) the first entity and the second entity. Multiple entities listed with “and/or” should be construed in the same manner, i.e., “one or more” of the entities so conjoined. Other entities may optionally be present other than the entities specifically identified by the “and/or” clause, whether related or unrelated to those entities specifically identified. Thus, as a non-limiting example, a reference to “A and/or B,” when used in conjunction with open-ended language such as “comprising” can refer, in one embodiment, to A only (optionally including entities other than B); in another embodiment, to B only (optionally including entities other than A); in yet another embodiment, to both A and B (optionally including other entities). These entities may refer to elements, actions, structures, steps, operations, values, and the like.

As described below, various dimensions have been specified in exemplary embodiments. This disclosure is not limited to such dimensions and any dimensions that may still ensure educational and safety compliance as described herein may be used for the various components of the various toys described herein. Further, various components are not limited to the shapes, sizes, colors, and/or materials as described herein. Any shapes, sizes, colors, and/or materials that may still ensure educational and safety compliance as described herein may be used for the various components of the various toys described herein. The weights of the toys described herein may be according to the user's needs while complying with the safety and educational testing requirements described herein. Finally, various surfaces, sides, and features of various components of the toys described herein are per how a person skilled in the art would construe those characteristics unless otherwise specified.

Currently, Montessori toys are being manufactured by companies, such as Heutink USA, Kid Advance, Montessori Outlet, Juliana Group, MVita, Leader Joy, and Alison's Montessori. Montessori toys supplied by these companies have tiny fine print on the back of the toys' packaging with labels warnings that states phrases such as “not safe for children under 3” and “suitable for 3 years+.” This is unsettling because these label markings are written on the packaging of toys that are all listed in the infant/toddler (implying children aged 0-3 years) sections of their websites and are based on the recommendations from the Association Montessori Internationale (“AMI”) 0-3 teacher's training manual. Currently, there are none or just a few safety compliant Montessori toys for 0-3-year-olds that have passed safety testing in the traditional wooden materials. There is no company that has a full, safety-compliant Montessori toy curriculum for 0-3-year-olds. In fact, only 4% of toys in the US have passed safety testing for children between 0-3 years old, and most of those toys are plastic and plush. Most toys fail to comply with the safety requirements not so much because of their chemical structure but because they do not pass the physical and/or mechanical tests.

After working for months and experimenting with various shapes and sizes of the toys, various inventions were developed. For example, rattles were particularly hard to develop. There are very few rattles on the market that are developmentally appropriate and small enough for the hands of children aged 0-3 years. The rattles recommended in the AMI teacher's training manual could not pass the safety tests. Accordingly, completely new rattles were designed that conformed with the highest safety and educational value standards. The invented designs were then submitted to contract manufacturers. The manufacturers' work product was then subjected to informal physical and/or mechanical safety testing, such as drop tests, compression tests, tension tests, small parts testing, rattle test, and/or fixture test at the inventor's lab. Most manufactured products failed again as they were still mostly constructed like the toys manufactured by Montessori toy suppliers listed above. Subsequently, all the toys were completely redesigned again until they passed the safety tests.

In some previous toy designs, after a long and arduous experimentation and redesign process, Monti Kids reached out to the best toy testing safety lab in the country: Bureau Veritas with headquarters in Buffalo, N.Y. where Fisher Price was founded. Fisher Price first started as a wooden toy company and eventually moved to plastic due to physical and/or mechanical safety testing challenges. After visiting Bureau Veritas with all the samples of the toys, Bureau Veritas advised the inventors to manufacture their toys in plastic. However, the inventors were determined to manufacture the toys in wood according to the Montessori educational standards while complying with the safety requirements as provided by various agencies such as CPSC, ASTM, etc. After the arduous redesign process, the inventors became experts in the safety standards, virtually memorizing all the relevant regulations. The inventors then set up a physical and/or mechanical safety testing site in their garage. The inventors would design the toys, model it in cardboard, then build it in wood, and then perform the physical and/or mechanical safety tests in their garage. This process was repeated multiple times for each toy and the results, such as what sizes and weights posed the biggest risk in each design, which type of wood would work best, which direction the wood grain had to flow, and which unique internal construction would work best for each design, were recorded. Subsequently, the inventor found two new contract manufacturers who had more experience building safe toys and submitted their new designs to the new contract manufacturers. Despite being told by others to use Bureau Veritas office in China in order to reduce testing costs, the inventors tested their toys in the Bureau Veritas office in Buffalo so that the inventors could closely follow the process, discuss any failings or concerns with Bureau Veritas, and continue to learn from them in the process. Some of the toys passed the safety tests and for those that did not, the inventors continued the redesign process till the best iteration for the toy was achieved. This long and arduous experimentation and redesign process has resulted in the inventors' company being the only company that carries a full line of Montessori toys that are safe for children aged 0-3 years. The safety tests that the toys had to pass vary toy by toy. The two hardest safety tests to pass were 16 CFR 1500 & ASTM F963-11. Especially, because, when things broke, they often violated the small part requirement of 16 CFR 1501. However, eventually, the inventors after multiple experiments manage to design toys, described below, which pass the relevant safety tests as described by various agencies such as CPSC, ASTM (F963-11 and other relevant testing standards), etc. Additionally, the inventors also developed a new and useful method of classifying various toys described below.

Currently, after hundreds of toys and safety tests, the inventors are generally able to predict what joinery, wood grain directions, toy weights, toy dimensions, edge circumferences, and architectures will pass safety testing. Accordingly, the inventors typically develop designs that may pass the safety testing the first time.

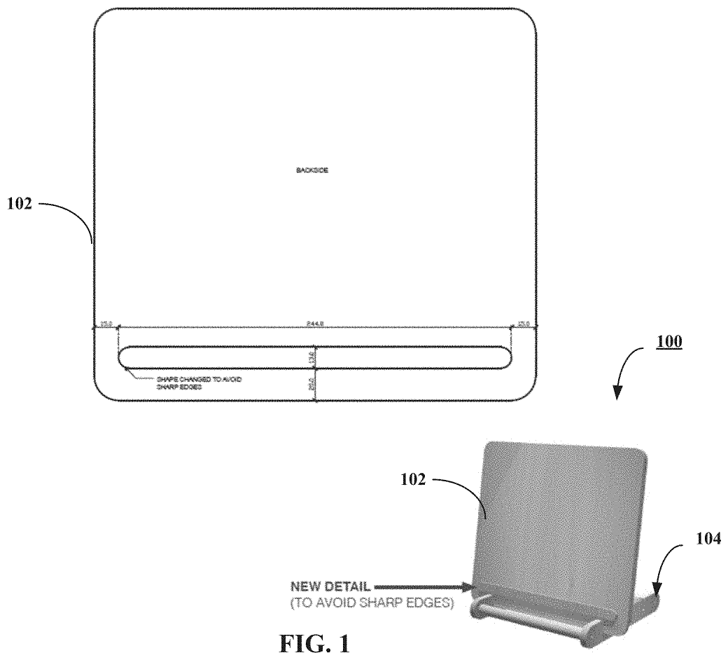

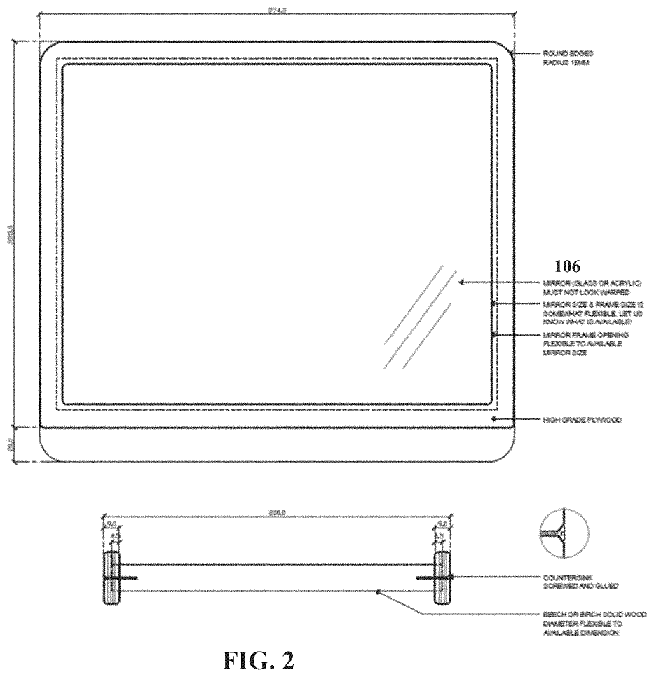

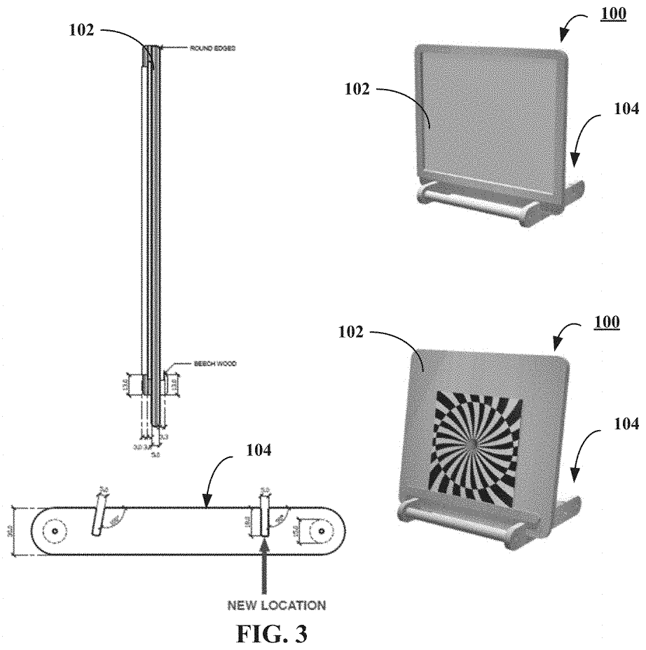

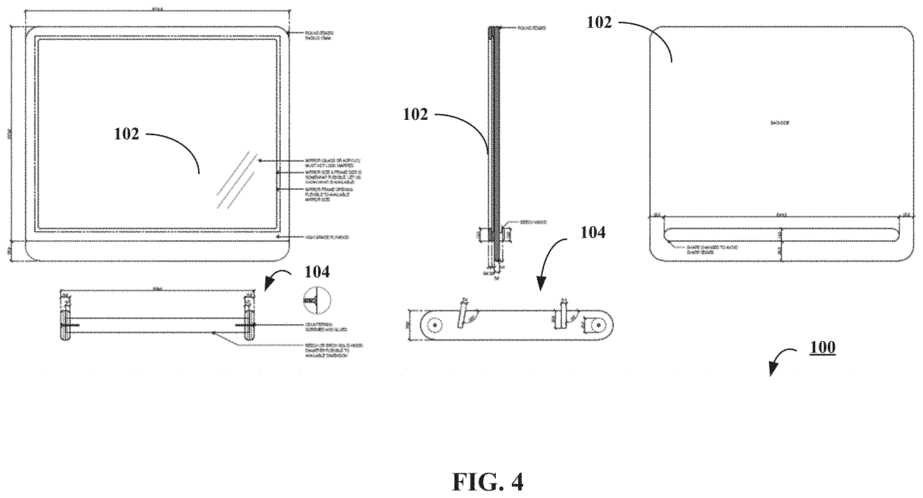

FIGS. 1-4 are diagrams illustrating a Montessori Newborn Kit toy, according to some embodiments of the present invention. More specifically, FIGS. 1-4 illustrate a stand 100 that holds a two-sided frame 102. The two-sided frame 102 may have one side that may be blank to be used with a set of images and another side that includes a mirror 106. The stand 100 may be low to the ground for an infant's use on their back or tummy. The stand 100 may also have a base 104 that includes two angled slits in order for the mirror 106 to be used vertically and the cards supported on the angle (e.g., so the cards do not fall off). A baby having a mirror 106 at floor height may allow for the baby to engage with and explore the baby's environment before the baby is able to move independently. In some embodiments, the mirror 106 may allow for that work to happen. In some embodiments details such as rounded edges may be provided that avoid sharp edges. Furthermore, in some embodiments, the stand may be made from plywood.

In an example embodiment, the mirror 106 may be an acrylic mirror. In an example embodiment, an acrylic mirror having a 2 mm thickness may be used. In an example embodiment, an acrylic mirror having a thickness in the range from 1 mm to 3 mm may be used. In an example embodiment, an acrylic mirror having a thickness in the range from 0.5 mm to 3.5 mm may be used. Generally, the thickness of the acrylic mirror may be uniformed. For example, the thickness of the acrylic mirror may be 2 mm±0.1 mm. In another example, the thickness of the acrylic mirror may be 3 mm±0.1 mm. In another example, the thickness of the acrylic mirror may be 1 mm±0.1 mm. In some examples, the thickness may vary by less than 0.01 mm. Other variances and other thicknesses are also possible.

As illustrated in the figures, in some example embodiments, the notches may be vertical or angled. In an example, a pair of notches (vertical or angled) may be used to hold the two-sided frame. In an example, a pair of vertical notches may be used to hold the two-sided frame with the mirror pointing towards a shorter end of the stand. In an example, a pair of angled notches may be used to hold the two-sided frame with the mirror pointing away from a shorter end of the stand. In another example, a pair of vertical notches may be used to hold the two-sided frame with the mirror pointing away from a shorter end of the stand. In an example, a pair of angled notches may be used to hold the two-sided frame with the mirror pointing toward a shorter end of the stand.

In an example embodiment, the mirror size and the frame size may be flexible. The mirror frame opening may vary to match the size of the mirror used. For example, the illustrated dimensions in the figure, e.g., 274 mm by 223 mm, 20 mm, 200 mm, 9 mm, 4.5 mm may vary by 1%, 5%, 10%, 100%, or various other ranges of sizes including, e.g., from 25% to 300%, from 10% to 500%, or greater. Any size that may be grasped and held by a baby, toddler, or small child may be used, provided the size does not result in a mirror that is too heavy for the baby, toddler, or small child to safely hold or use.

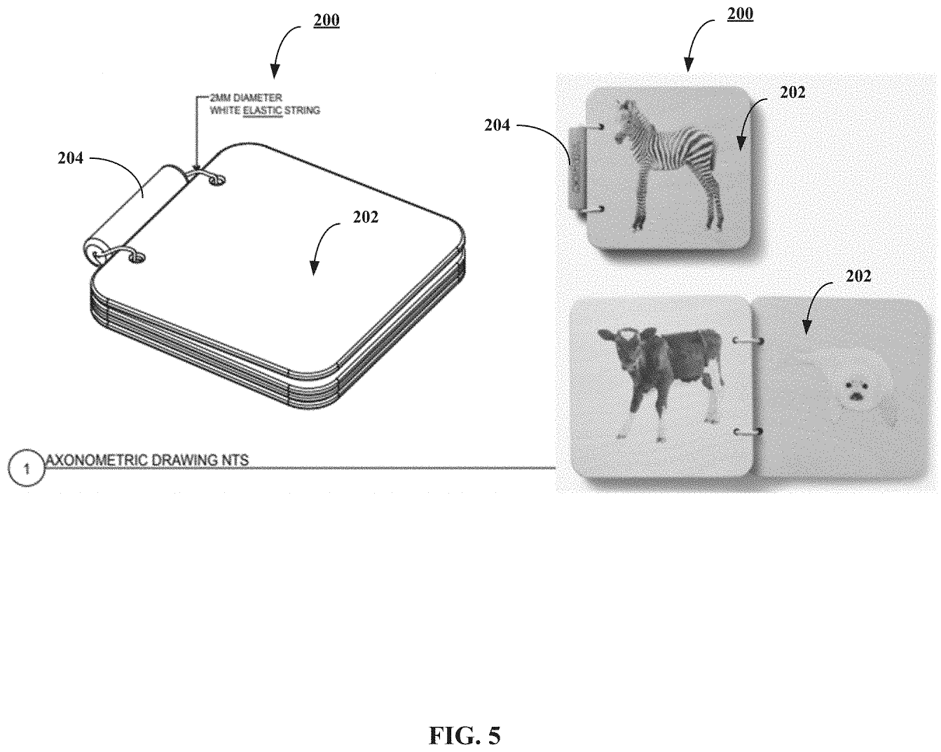

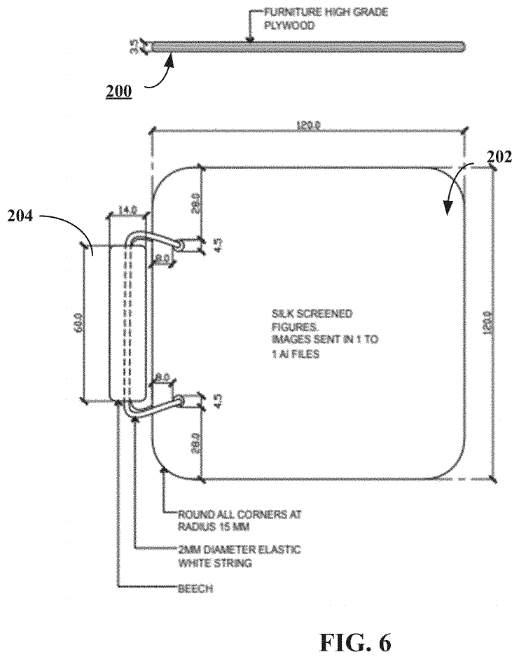

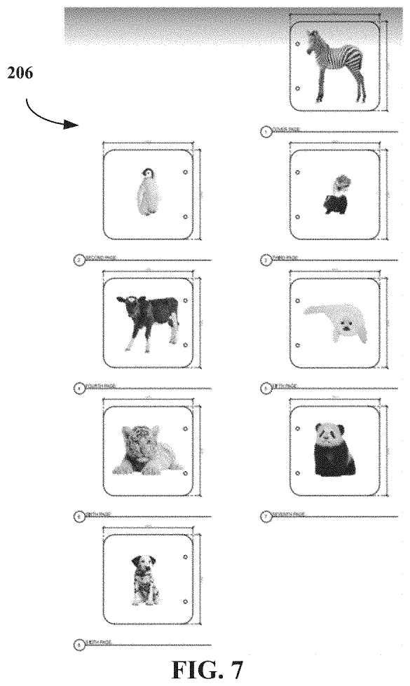

FIGS. 5-7 are diagrams illustrating a Montessori Newborn Kit toy, according to some embodiments of the present invention. More specifically, FIGS. 5-7 are diagrams illustrating a book 200 with black and white pictures 206 of animals. Just after birth, a baby sees only in black and white, with shades of gray. As the months go by, they will slowly start to develop their color vision at around 4 months. Accordingly, diagrams illustrating a book 200 with black and white may be appropriate visual stimulation for young babies, e.g., from birth to approximately 4 months.

The book 200 may be also created uniquely for a baby to use in many ways. First, the book 200 may be created for use by the baby while the baby is in a caregiver's arms. Next, being made from wood, the book 200 may be created to be safely propped up for a baby to use during “tummy time,” e.g., when the baby is laying on the baby's stomach, e.g., on the floor, on a bed, in a crib, or otherwise laying down. The book 200 may also be used by the baby when the baby is sitting up independently. The book 200 may have easy to turn and grasp pages. Furthermore, the book 200 may safely be mouthed without damage to the book 200.

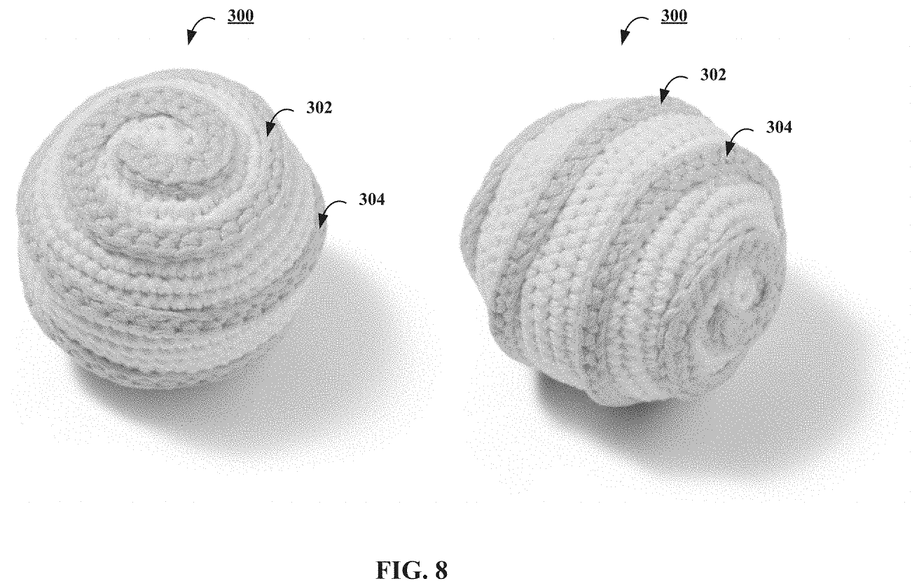

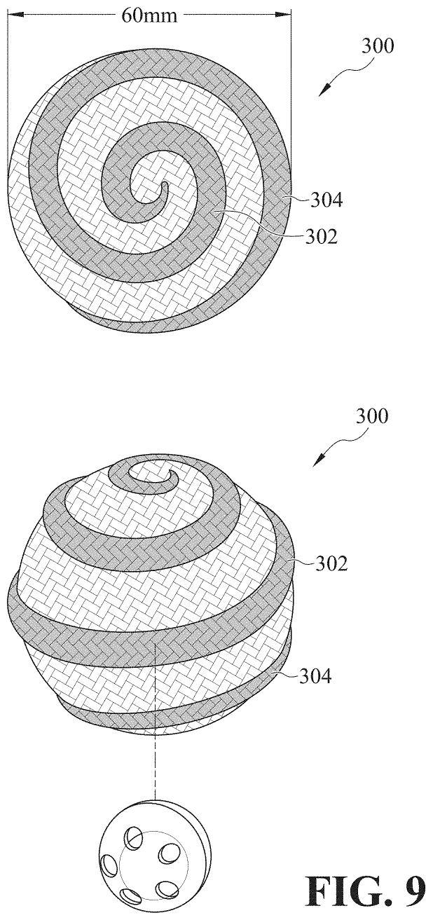

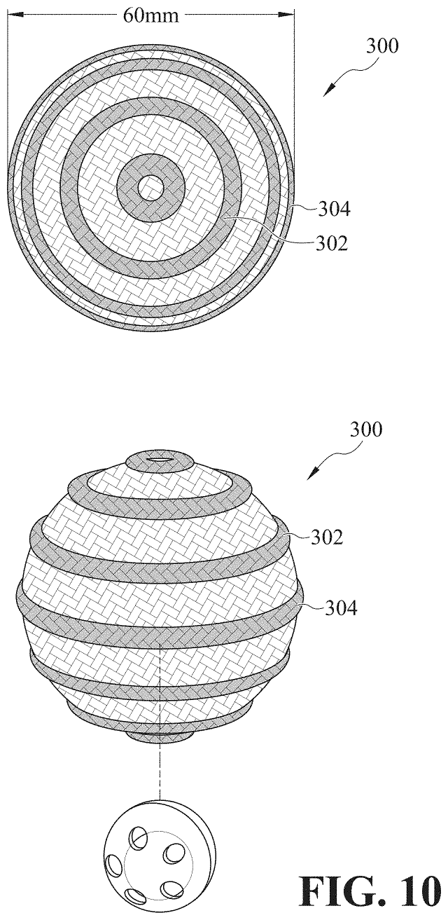

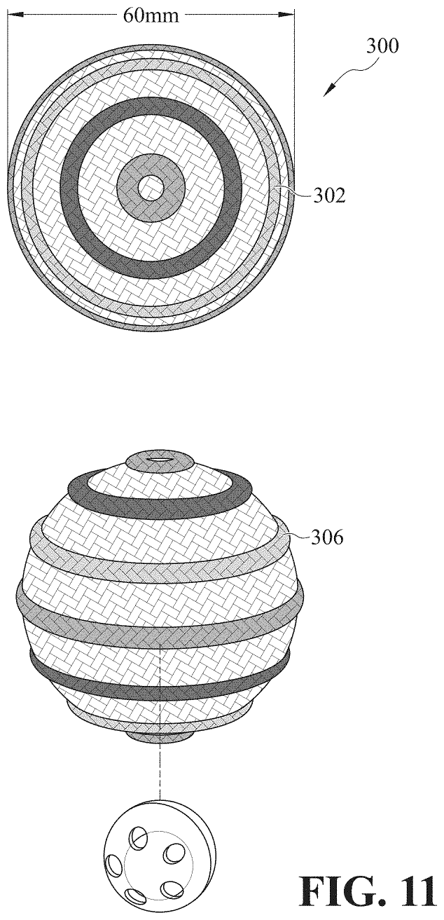

FIGS. 8-11 are diagrams illustrating a Montessori Newborn Kit toy, according to some embodiments of the present invention. More specifically, FIGS. 8-11 are diagrams illustrating a ball 300 having a raised portion 302. The raised portion 302 may be made up of individual separate individual raised portions 306, e.g., FIG. 11, or the raised portion may form a corkscrew pattern 304 on the ball 300. The raised portion 302 may form a ribbing around the ball 300, e.g., FIGS. 8-10. Accordingly, the ribbing may be made up of separate individual raised portions (304), e.g., FIG. 11, or the ribbing 304 may form a corkscrew pattern on the ball, e.g., FIGS. 8-10. In an example embodiment, a bell or other noise generating device may be inside the ball 300 (FIGS. 9-11).

In an example, infants may need lightweight and varied materials for playtime success and development. The ball may allow for both lightweight and varied materials. The size and weight of the ball may allow for ease of use and when ready, rolling slightly to promote further development. The unique ribbing around the ball further allows for an infant to grasp the ball and bring to the ball to their mouth. The crochet material and fabric allow for a varied material in their play space different from wood, silicone, or plastic. Additionally, the ribbing may lower the roll distance of the ball, which may be important for children that are not yet able to walk or crawl. By lowering the rolling distance of the ball, the baby may more easily retrieve the ball when the ball rolls away keeping the ball from rolling so far that the ball is outside the baby's sense of the baby's own play area. When a ball or other toy rolls or moves too far, a baby playing with the ball or other toy may perceive the ball or other toy as gone for good.

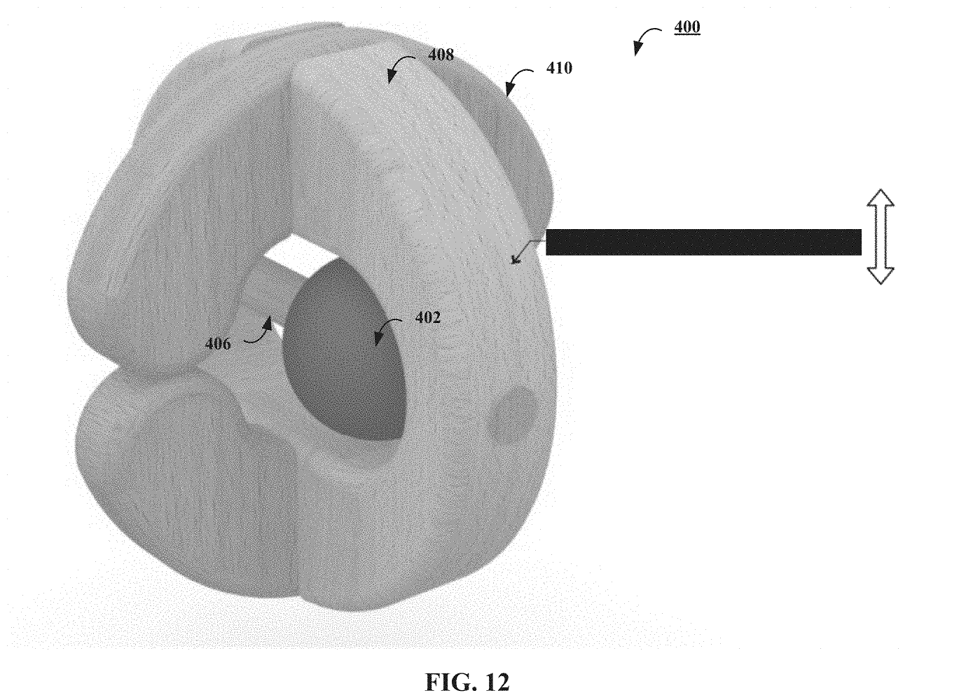

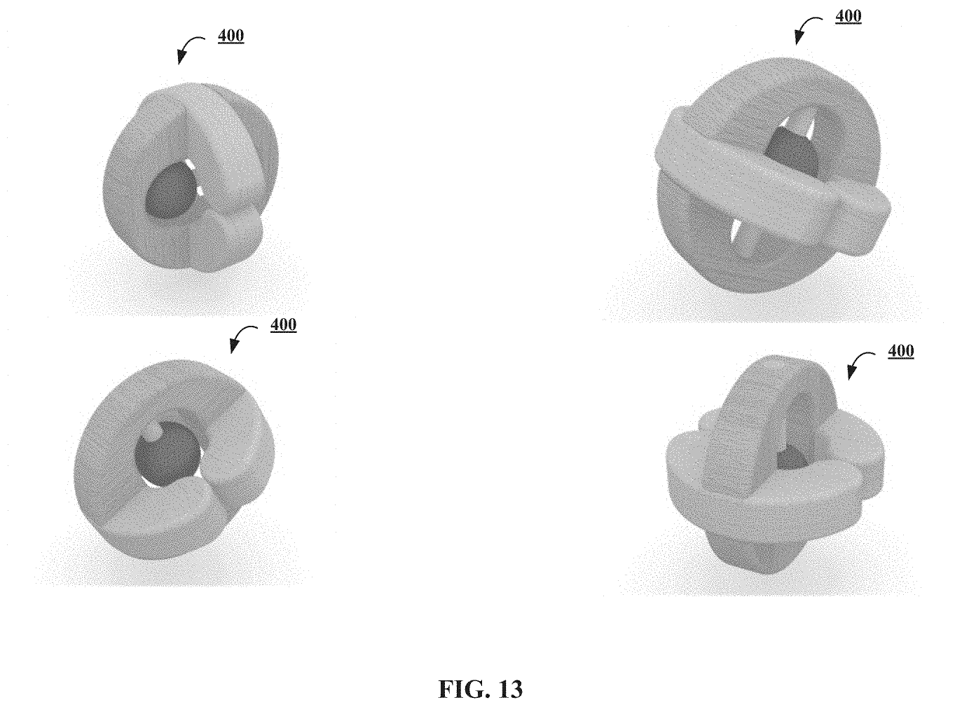

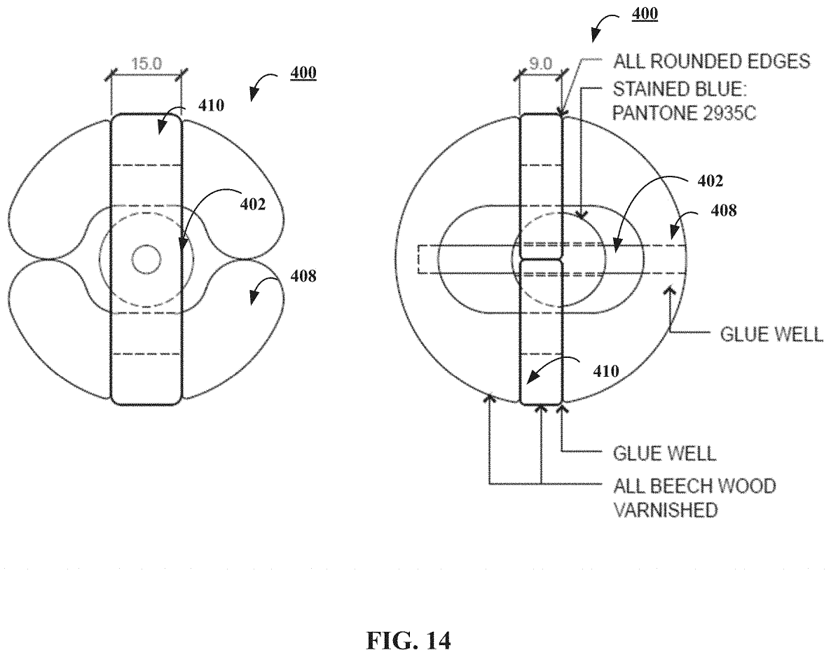

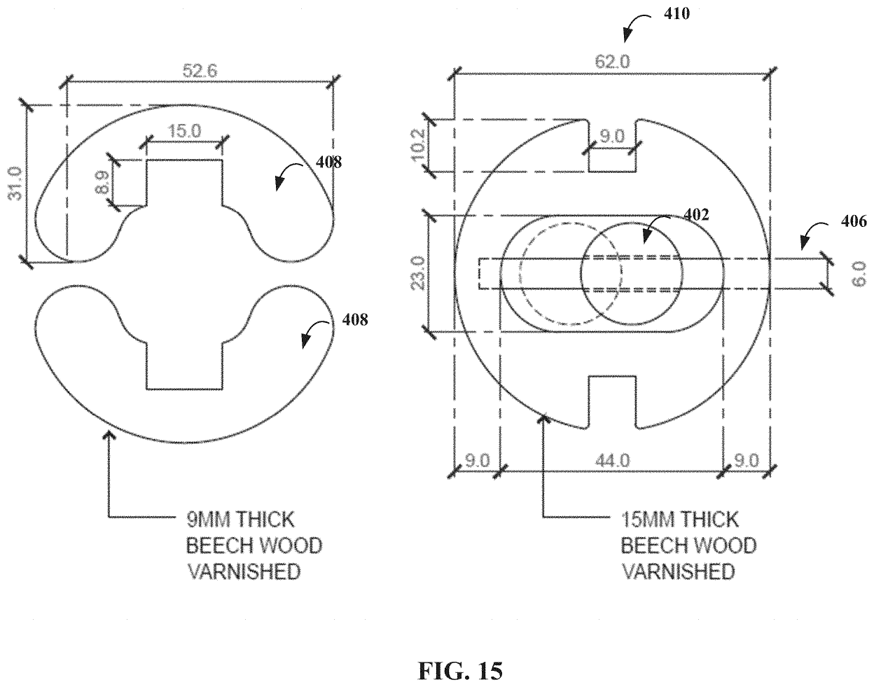

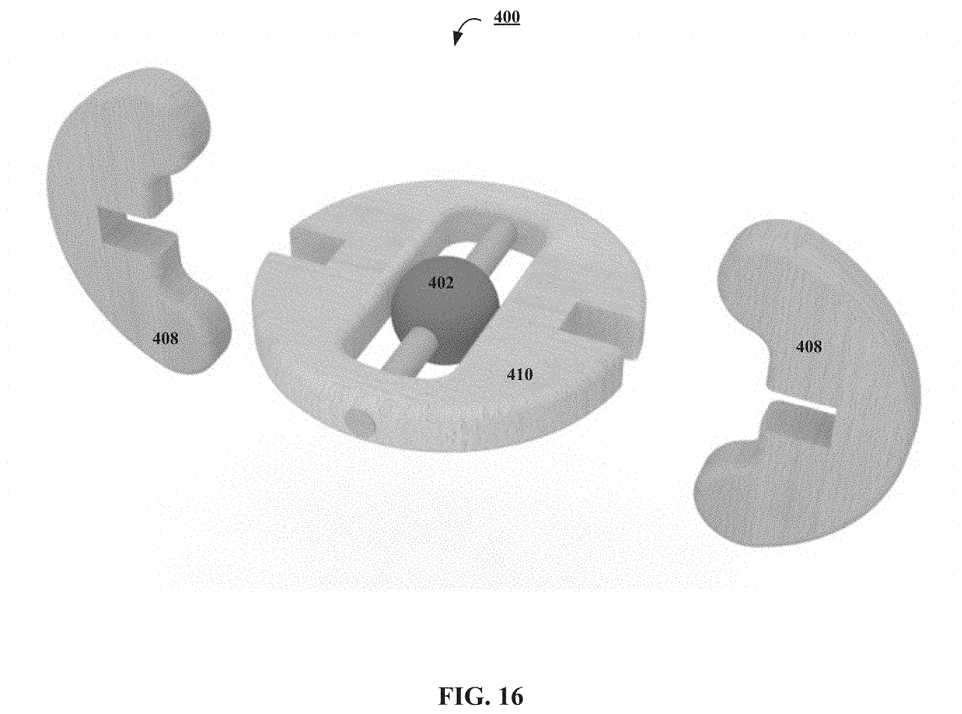

FIGS. 12-16 are diagrams illustrating a Montessori Newborn Kit toy, according to some embodiments of the present invention. More specifically, FIGS. 12-16 are diagrams illustrating a rattle 400 that may be created for extended play. An example embodiment may be made from lightweight wood material. Some examples may be made from plywood. Some example embodiments may have cut outs. In an example made from lightweight wood material and having cut outs, the lightweight material and cut outs may allow for easy grasping and mouthing by a baby or toddler. An example embodiment may include a ball 402 inside the outer frame 404 of the rattle. In an example embodiment, the ball 402 inside may move with use. Movement of the ball 402 with use may stimulate a baby's senses. The construction may be done with two-part security. The two-part security may allow there to be no or a very low risk (the toy may be particularly safe). For example, the ball 402 may be on a shaft 406. The shaft 406 may be difficult or impossible to remove, e.g., without damaging the toy 400. The ball 402 may be within a first portion of the rattle and the ball 402 and the first portion of the rattle 400 may be further enclosed by a pair of side pieces 408, 410. FIG. 16 illustrates these side pieces 408, 410 exploded out from the rest of the rattle. When assembled, the side pieces 408, 410 further enclose the ball 402.

When used on the floor, the toy (rattle 400) may roll in a special way. The rolling in a special way may entice further development and movement from a baby playing with the rattle. For example, the rattle 400 may “wobble” as the rattle rolls. The wobble while rolling may also keep the rattle 400 within the baby's play area. For example, a rattle 400 that wobbles may not roll as far. Accordingly, as with the ribbing discussed above, the wobble may lower the roll distance, which may be important for children that are not yet able to walk or crawl. By lowering the roll distance, the baby may more easily retrieve the rattle when the rattle rolls away keeping the rattle from rolling so far that the ball is outside the baby's perceived play area.

In an example embodiment, the grain direction of the wood used to make a first outer portion of the rattle may run perpendicular to the direction of travel of the ball 402 along the shaft. Accordingly, the direction of the grain may also be perpendicular to the direction of the shaft or dowel. In an example embodiment, the grain direction of the wood used to make a second outer portion of the rattle may run parallel to the grain direction of the wood used to make the first outer portion.

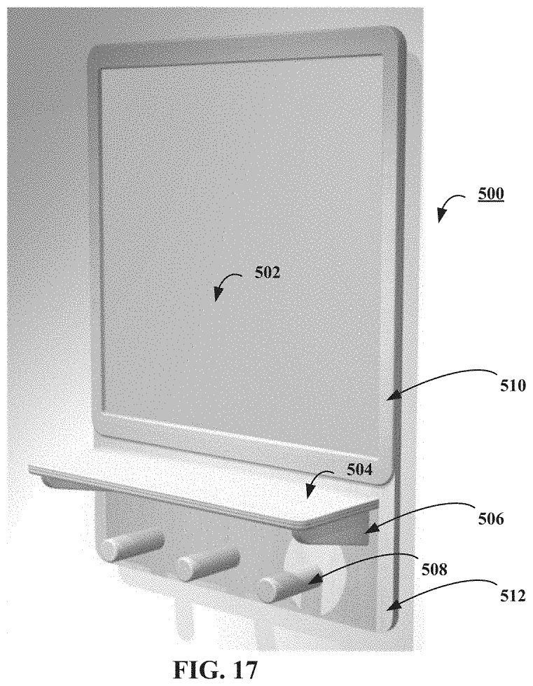

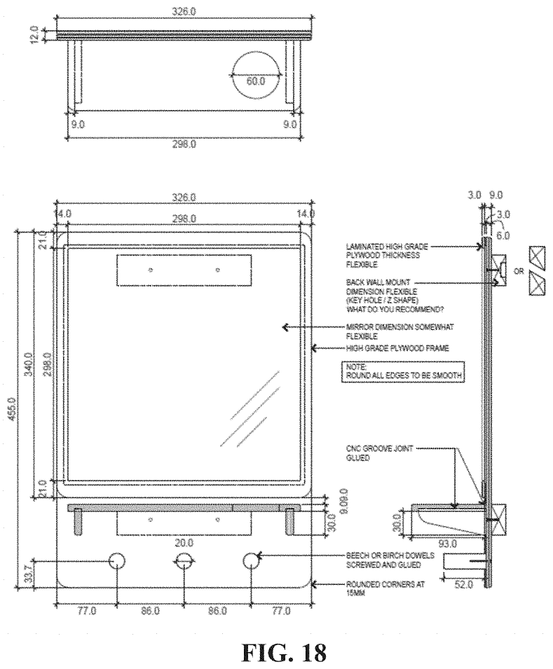

FIGS. 17-18 are diagrams illustrating a Montessori Self-Care Station, according to some embodiments of the present invention. More specifically, FIGS. 17-18 are diagrams illustrating a unique combination 500 of a shelf 504 and mirror 502 made child-sized to hang at a low height. Can be used in many locations around the home. Unlike others on the market that are piece-meal and put together this is all in one to allow for both the purpose of the Self Care Montessori shelf and the independence of the low mirror.

In an example, a toy (combination 500) includes a frame 510, an acrylic mirror, (e.g., mirror 502) within the frame 510, a shelf 504 coupled to the frame 510 and substantially perpendicular to the frame 510, and at least one dowel 508 extending from the backing 512 and substantially perpendicular to the backing. The toy may have shelf supports 506.

As discussed above with respect to the mirror in FIGS. 1-4, in an example embodiment of the mirror 502 of FIGS. 17-18, an acrylic mirror may be used. In an example embodiment, an acrylic mirror having a 2 mm thickness may be used. In another example embodiment, an acrylic mirror having a thickness in the range from 1 mm to 3 mm may be used. In another example embodiment, an acrylic mirror having a thickness in the range from 0.5 mm to 3.5 mm may be used. Generally, the thickness of the acrylic mirror may be fairly uniformed. For example, the thickness of the acrylic mirror may be 2 mm±0.1 mm. In another example, the thickness of the acrylic mirror may be 3 mm±0.1 mm. In another example, the thickness of the acrylic mirror may be 1 mm±0.1 mm. In some examples, the thickness may vary by less than 0.01 mm. Other variances and other thicknesses are also possible.

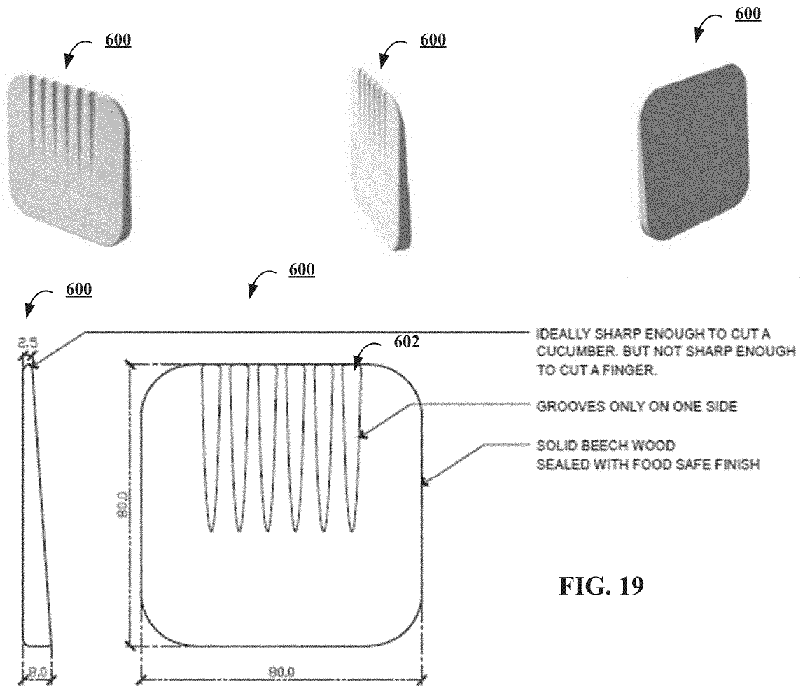

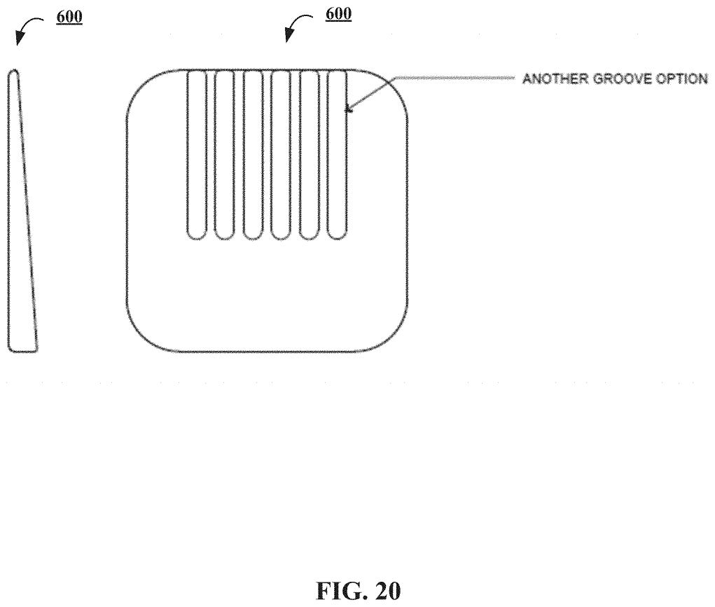

FIGS. 19-20 are diagrams illustrating a Montessori Cooking Together Kit toy, according to some embodiments of the present invention. More specifically, FIGS. 19-20 are diagrams illustrating a wood cutter or chopper 600. Creating a safe way for a toddler to chop and prepare food alongside their caregiver was a challenge. A chopper that is too sharp may be too dangerous to a baby, toddler, or small child. A chopper that is not sharp may not be useful.

Preparing food may be an important part of the Montessori Practical Life curriculum and a component to a toddler's development. Using food safe wood and materials, a wedge with grooves has been created. The wedge with grooves may be used to chop and slice a wide variety of foods, e.g., such as fruits and vegetables. The chopper does not have sharp edges, however, which allowed for the chopper to pass safety testing for children under the age of three. Accordingly, the chopper may be used by a young child safely when a child is ready.

In an embodiment, the chopper 600 may be able to cut, e.g., a cucumber, but not sharp enough to cut a finger. In the illustrated embodiment grooves 602 may be in one side only. In other embodiments, grooves 602 may be in both sides. In yet other embodiments, grooves 602 may be on both sides and the grooves 602 may be offset from each other. In an example embodiment, the chopper 600 may be made from beech wood. In other embodiments, other wood types may be used, such as rubberwood, bamboo, and birch. In other embodiments, materials other than wood may be used, such as silicone.

In the example of FIG. 19, the “blade” may be 2.5 mm wide. Wider or narrower blades may be used. For example, blades from 1.5 mm to 3.5 mm may be used. In another example, blades from 1.0 mm to 4.0 mm may be used. Blades that are too thin may be too sharp or too weak. Blades that are too thick may mash food rather than cut the food. Additionally, the “blade” may be rounded as illustrated in FIG. 19.

The example of FIG. 19 includes an 8.0 mm thick end opposite the “blade” end. This end may also be different sizes, e.g., from 4.0 mm or less to 16.0 mm or more. The size of the chopper may also vary from the illustrated 80.0 mm by 80.0 mm. For example, the chopper may be smaller than 80.0 mm by 80.0 mm or larger than 80.0 mm by 80.0 mm. The chopper 600 may be longer, e.g., more like a knife blade (but not as sharp). A wide range of sizes are possible. However, the size selected should generally be easily grasped by a baby or toddler.

The toys of FIGS. 1-20 may be made of wood. In some embodiments, the toys of FIGS. 1-21 may include plywood. In some embodiments, the toys of FIGS. 1-20 may include one or more child safe varnishes. In some embodiments, the toys of FIGS. 1-20 may include one or more child safe paints or stains. In some embodiments, the toys of FIGS. 1-20 may include one or more child safe glues. In some embodiments, the toys of FIGS. 1-20 may include one or more child safe epoxies. In some embodiments, the toys of FIGS. 1-20 may include one or more child safe fasteners.

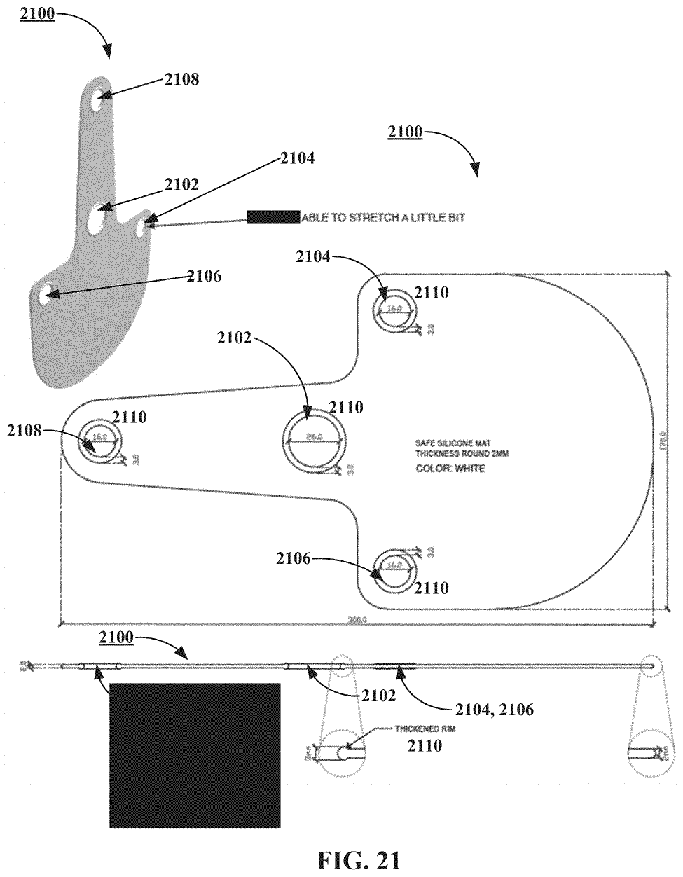

FIG. 21 is a diagram illustrating a faucet extender 2100, according to some embodiments of the present invention. In an example embodiment, a silicone material may be used as a faucet extension to extend the reach of a spout for toddlers at the sink. In an example embodiment, the faucet extender may be used by small children, toddlers, disabled adults, or anyone wanting to reposition a flow of water in a sink, e.g., from a faucet of the sink.

In an example embodiment, the faucet extender may modify a child's environment to allow them to be more independent and autonomous. Small children and toddlers may learn to care for themselves using the faucet extender. The silicone material of the faucet extender may be made with a unique flat design. In some embodiments, the use of plastic may be avoided to allow for the flat design.

Additionally, the silicone material of the faucet extender may have a stretch function. The stretch function may allow the faucet extender to fit many different sinks on the market. More specifically, the stretch function may allow the faucet extender to fit many different faucets on the market. In some embodiments, no hard plastic is used. Additionally, in some embodiments, the faucet extender may ship flat.

In some embodiments, one or more holes 2102, 2104, 2106, 2108 in the faucet extender may be able to stretch to attached to a faucet.

Different embodiments may have different lengths for the narrow portion of the faucet extender. Having different lengths for the wide portion of the faucet extender may provide faucet extenders with different lengths of spout. Having different lengths of spout may be used in different size sinks or may be used to modify the water flow differently within one sink.

In some embodiments, one or more holes in the faucet extender may have a thickened rim 2110. The thickened rim 2110 may provide additional strength at the hole (or holes). The thickened rim 2110 may provide additional frictional holding on a faucet that may go through the hole (or holes).

FIG. 21 illustrates example dimensions of an example faucet extender. Other dimensions for a faucet extender are also possible. For example, the dimensions may be slightly larger or smaller and still work with the same typical sink and faucet combinations, e.g., up to ±1%, up to ±10%, or other sizes. Alternatively, the dimensions may be much larger or smaller to work with non-typical sizes of sink and faucet combinations, e.g., up to ±100%, up to ±200%, or other sizes, depending on the size of the sink, the size of the faucet, or the sizes of both the sink and the faucet. Furthermore, the shape of the faucet extender is only an example shape. Accordingly, it will be understood that the size and shape of the faucet extender of FIG. 21 is only an example.

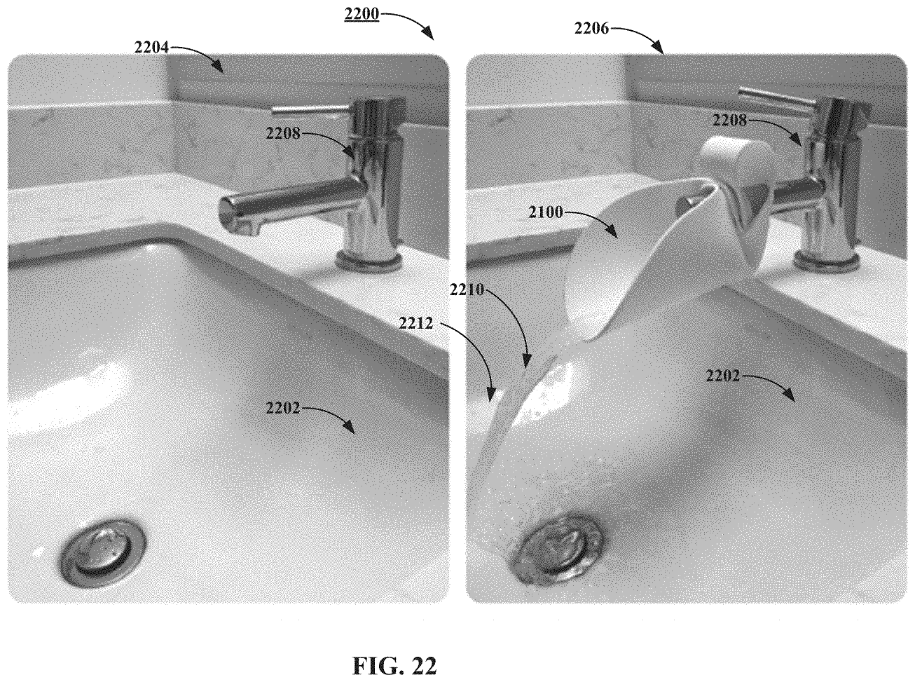

FIG. 22 is a diagram 2200 illustrating an example sink 2202 without a faucet extender 2100 installed (2204) and an example of the sink 2202 with an installed faucet extender 2100 (2206), according to some embodiments of the present invention. As is illustrated in FIG. 22, the faucet extender 2100 may attach to the faucet 2208. Additionally, the faucet extender 2100 may divert water closer to a portion 2212 of the sink 2202 that a user may more easily reach. Diverting water closer to a portion 2212 of the sink 2202 that a user may more easily reach may be particularly helpful for small children, toddlers, or people with disabilities. For example, small children or toddlers may be too small to reach the flow of water unless the flow of water is diverted.

Similarly, some adults may be too small in stature to reach water flow in a typical sink. Additionally, some people in wheelchairs or other mobility devices may have trouble reaching the water flow in a typical sink. Accordingly, the faucet extender may be helpful to small children, toddlers, or people with disabilities, and their family or friends by allowing these people to more easily use the sink to, for example, wash their hands, fill a glass of water, or other activities performed at a sink.

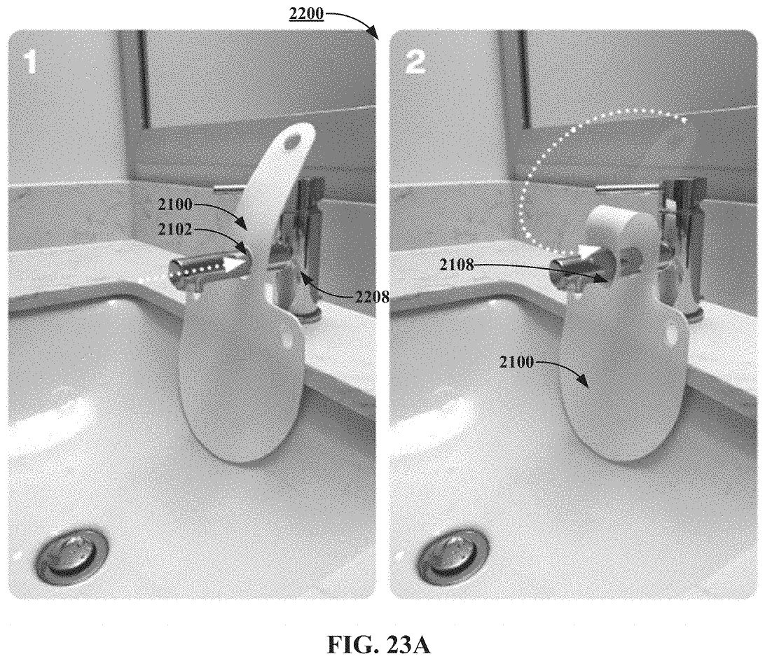

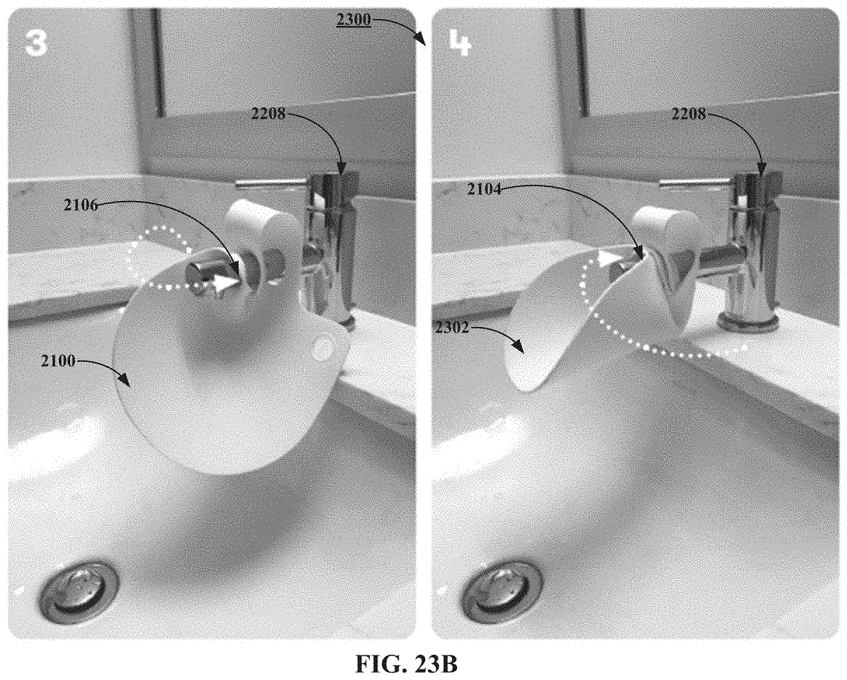

FIGS. 23A-23B are diagrams 2300 illustrating a faucet extender 2100 installation, according to some embodiments of the present invention. In step 1, the faucet extender 2100 may be attached to a faucet 2208 through a first hole 2102 by feeding the faucet 2208 through the first hole 2102, e.g., sliding the faucet extender 2100 onto the faucet 2208 at the first hole 2102 as illustrated in FIG. 23A. In step 2, the faucet extender 2100 may be attached to the faucet 2208 through a second hole by folding a portion of the faucet extender down and feeding the faucet through the second hole 2108, e.g., sliding the faucet extender 2100 onto the faucet 2208, e.g., at the second hole 2108 as illustrated in FIG. 23A. In step 3, the faucet extender 2100 may be attached to the faucet 2208 through a third hole 2106 by folding a portion of the faucet extender 2100 across and feeding the faucet 2208 through the third hole 2106, e.g., sliding the faucet extender 2100 onto the faucet 2208, e.g., at the third hole 2106 as illustrated in FIG. 23B. In step 4, the faucet extender 2100 may be attached to the faucet 2208 through a fourth hole 2104 by folding a portion of the faucet extender 2100 across and feeding the faucet 2208 through the fourth hole 2104, e.g., sliding the faucet extender 2100 onto the faucet 2208, e.g., at the fourth hole 2104 as illustrated in FIG. 23B. In some embodiments, step 3 and step 4 may be done in reverse order. Accordingly, the orders 1, 2, 3, 4; and 1, 2, 4, 3 may both be possible in some embodiments. In some embodiments, the steps may be done in the order 1, 3, 4, 2. In some embodiments, the steps may be done in the order 1, 4, 3, 2. It will be understood that these are only example step orders, and other step orders are also possible. In an example embodiment, holes 3 and 4 may hold the faucet extender to form a spout 2302. As illustrated, the spout 2302 may divert the flow of water from a faucet that has the faucet extender installed on it. For example, the spout 2302 may divert the flow of water to the middle or just inside an outer edge of a sink.

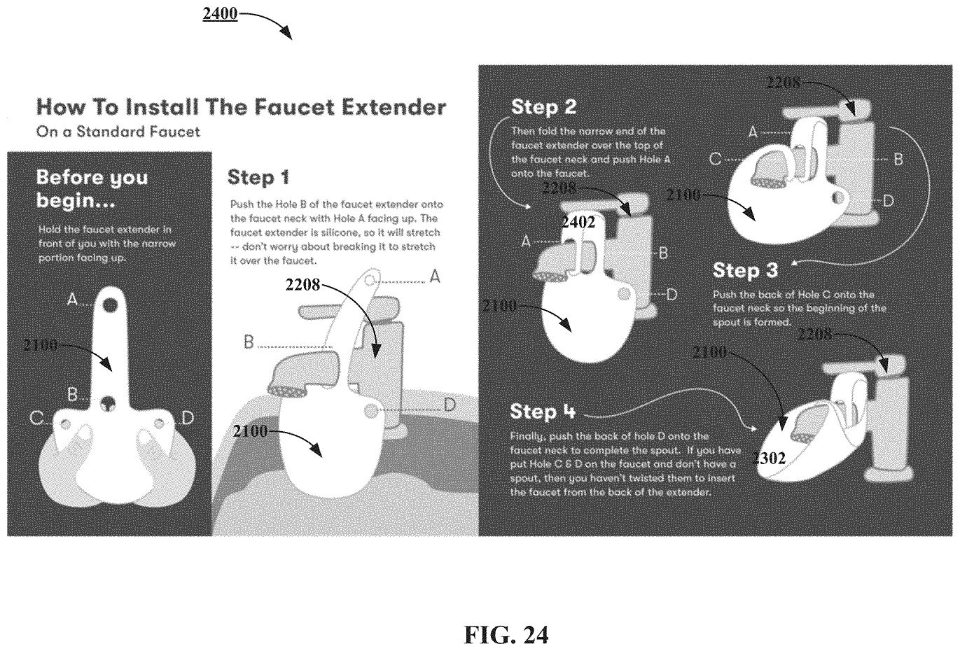

FIG. 24 is a diagram 2400 illustrating a faucet extender 2100 installation on a standard faucet 2208, according to some embodiments of the present invention. FIG. 24 illustrates how to install a faucet extender 2100 on a standard faucet 2208. Before you begin, hold the faucet extender 2100 in front of you with the narrow portion facing up. In step one, push the hole B of the faucet extender 2100 onto the faucet 2208 neck with the hole A facing up. The faucet extender 2100 may be silicon. Accordingly, the faucet extender 2100 may stretch. In some embodiments, do not worry about breaking the faucet extender 2100 to stretch the faucet extender 2100 over the faucet 2208. In Step 2, fold the narrow end 2402 of the faucet extender 2100 over the top of the faucet 2208 neck and push hole A onto the faucet. In Step 3, pushed the back of whole C onto the faucet 2208 neck so that the beginning of the spout 2302 is formed. In Step 4, pushed the back of hole D onto the faucet 2208 neck to complete the spout 2302. If you have put whole C and D on the faucet 2208 and do not have a spout 2302, then you have not twisted them to insert the faucet 2208 from the back of the extender. In some example embodiments, the order of installation of hole C and hole D onto the faucet 2208 may be reversed.

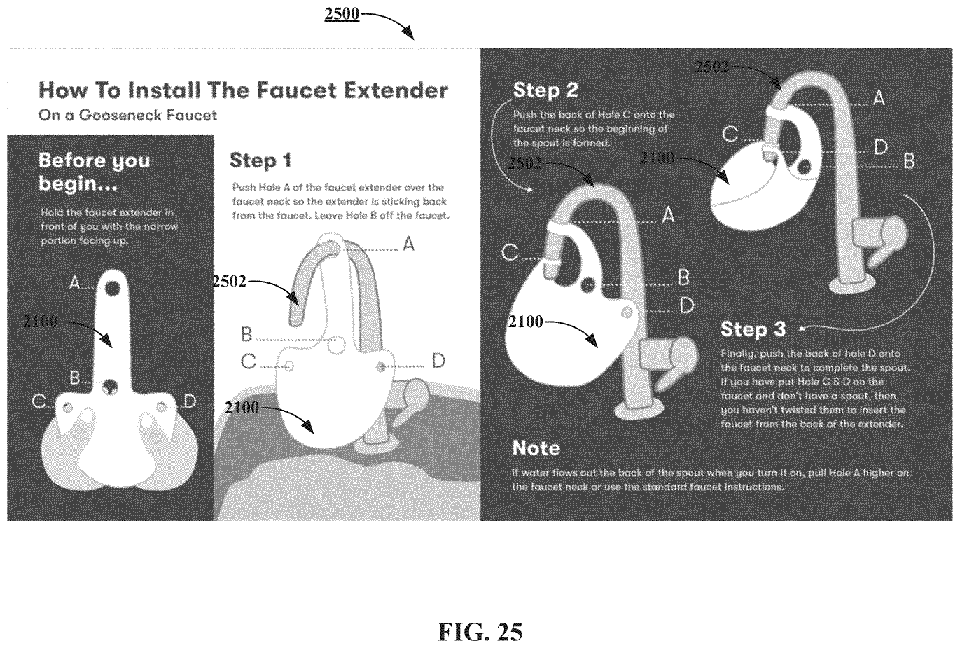

FIG. 25 is a diagram illustrating a faucet extender 2100 installation on a gooseneck faucet 2502, according to some embodiments of the present invention. FIG. 25 illustrates how to install a faucet extender 2100 on a gooseneck faucet 2502. Before you begin, hold the faucet extender 2100 in front of you with the narrow portion facing up. In step 1, push hole A of the faucet extender 2100 over the faucet 2502 neck, so the extender is sticking back from the faucet 2502. Leave hole B off the faucet 2502. In Step 2, push the back of hole C onto the faucet 2502 neck, so the beginning of the spout 2302 is formed. Step 3, push the back of hole D onto the faucet 2502 neck to complete the spout. If you have put holes C and D on the faucet 2502 and do not have a spout 2302, then you have not twisted them to insert the faucet from the back of the extender. Note, if water flows out the back of the spout 2302 when you turn the faucet 2502 on, pull hole A higher on the faucet 2502 neck or use the standard faucet instructions. In some example embodiments, the order of installation of hole C and hole D onto the faucet 2502 may be reversed.

An aspect includes a faucet extender 2100, including a flat material having a first hole 2102, “b” configured to receive a faucet 2208, 2502, the flat material having a second hole configured to receive the faucet 2208, 2502, the flat material having a third hole configured to receive the faucet, the faucet extender 2100 configured to form a spout 2302 when the second hole and the third hole are installed on the faucet.

In an aspect, the faucet extender 2100 is made from silicone.

In an aspect, at least one hole of the first hole, the second hole, and the third hole include a thickened rim 2110.

In an aspect, the faucet extender 2100 includes a fourth hole configured to receive the faucet.

An aspect includes a method of installing a faucet extender 2100, including providing a flat material having a first hole configured to receive a faucet, the flat material having a second hole configured to receive the faucet, the flat material having a third hole configured to receive the faucet, the faucet extender configured to form a spout 2302 when the second hole and the third hole are installed on the faucet, installing the faucet extender on the faucet through the first hole, installing the faucet extender on the faucet through the second hole, and installing the faucet extender 2100 on the faucet through the third hole, the installation through the second hole and the third hole forming a spout 2302.

In an aspect, the method further including installing the faucet extender 2100 on the faucet 2208, 2502 through the fourth hole.

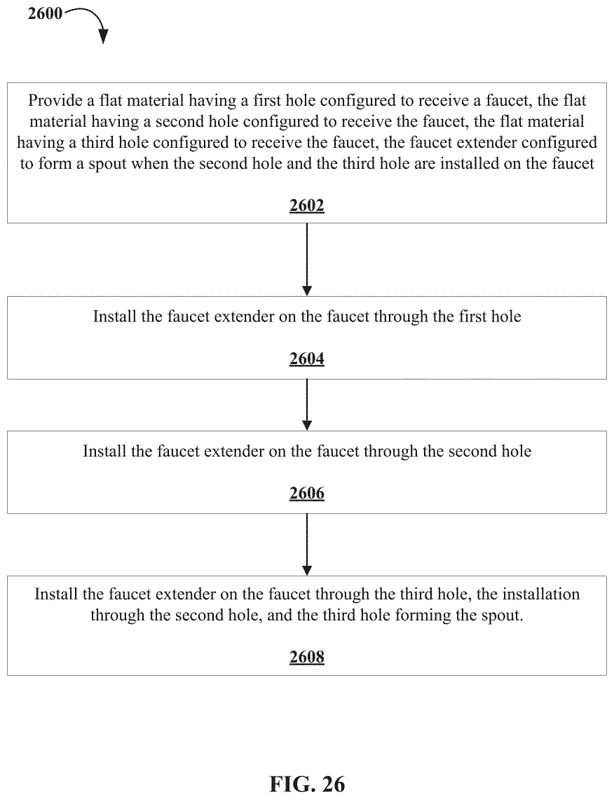

FIG. 26 is a flow diagram illustrating an example method 2600 according to some embodiments of the present invention. The method 2600 may be a method of installing a faucet extender 2100. The method may include providing a flat material having a first hole configured to receive a faucet 2208, 2502, the flat material having a second hole configured to receive the faucet 2208, 2502, the flat material having a third hole configured to receive the faucet 2208, 2502, the faucet extender 2100 configured to form a spout 2302 when the second hole and the third hole are installed on the faucet 2208, 2502 (2602). Additionally, the method 2600 may include installing the faucet extender 2100 on the faucet 2208, 2502 through the first hole (2604). The method 2600 may also include installing the faucet extender 2100 on the faucet 2208, 2502 through the second hole (2606). Additionally, the method 2600 may include installing the faucet extender 2100 on the faucet 2208, 2502 through the third hole, the installation through the second hole, and the third hole forming the spout 2302 (2608). It will be understood that the order of the steps illustrated in FIG. 26 may vary from the order presented in FIG. 26.

In an example embodiment, the first hole is at least 26.0 mm in diameter and includes a 3.0 mm thickened rim.

In an example embodiment, the second hole is at least 16.0 mm in diameter and includes a 3.0 mm thickened rim.

In an example embodiment, the third hole is at least 16.0 mm in diameter and includes a 3.0 mm thickened rim.

In an example embodiment, the fourth hole is at least 16.0 mm in diameter and includes a 3.0 mm thickened rim.

The foregoing description of the embodiments of the present invention has been presented for the purposes of illustration and description. It is not intended to be exhaustive or to limit the present invention to the precise form disclosed. Many modifications and variations are possible in light of the above teaching. It is intended that the scope of the present invention be limited not by this detailed description, but rather by the claims of this application. As will be understood by those familiar with the art, the present invention may be embodied in other specific forms without departing from the spirit or essential characteristics thereof. Likewise, the particular naming and division of the modules, routines, features, attributes, methodologies and other aspects are not mandatory or significant, and the mechanisms that implement the present invention or its features may have different names, divisions and/or formats.

Furthermore, as will be apparent to one of ordinary skill in the relevant art, the modules, routines, features, attributes, methodologies and other aspects of the present invention can be implemented as software, hardware, firmware or any combination of the three. Also, wherever a component, an example of which is a module, of the present invention is implemented as software, the component can be implemented as a standalone program, as part of a larger program, as a plurality of separate programs, as a statically or dynamically linked library, as a kernel loadable module, as a device driver, and/or in every and any other way known now or in the future to those of ordinary skill in the art of computer programming.

Additionally, the present invention is in no way limited to implementation in any specific programming language, or for any specific operating system or environment. Accordingly, the disclosure of the present invention is intended to be illustrative, but not limiting, of the scope of the present invention, which is set forth in the following claims.

It is understood that the specific order or hierarchy of blocks in the processes/flowcharts disclosed is an illustration of example approaches. Based upon design preferences, it is understood that the specific order or hierarchy of blocks in the processes/flowcharts may be rearranged. Further, some blocks may be combined or omitted. The accompanying method claims present elements of the various blocks in a sample order and are not meant to be limited to the specific order or hierarchy presented.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but is to be accorded the full scope consistent with the language claims, wherein reference to an element in the singular is not intended to mean “one and only one” unless specifically so stated, but rather “one or more.” The word “exemplary” is used herein to mean “serving as an example, instance, or illustration.” Any aspect described herein as “exemplary” is not necessarily to be construed as preferred or advantageous over other aspects. Unless specifically stated otherwise, the term “some” refers to one or more. Combinations such as “at least one of A, B, or C,” “one or more of A, B, or C,” “at least one of A, B, and C,” “one or more of A, B, and C,” and “A, B, C, or any combination thereof” include any combination of A, B, and/or C, and may include multiples of A, multiples of B, or multiples of C. Specifically, combinations such as “at least one of A, B, or C,” “one or more of A, B, or C,” “at least one of A, B, and C,” “one or more of A, B, and C,” and “A, B, C, or any combination thereof” may be A only, B only, C only, A and B, A and C, B and C, or A and B and C, where any such combinations may contain one or more member or members of A, B, or C. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. The words “module,” “mechanism,” “element,” “device,” and the like may not be a substitute for the word “means.” As such, no claim element is to be construed as a means plus function unless the element is expressly recited using the phrase “means for.”

1-13. (canceled)

14. A shelf comprising:
a wooden backing;
a mirror backed by the wooding backing;
a frame, coupled to the wooden backing and configured to hold the mirror,
a shelf, coupled to the wooden backing and extending out from the wooden backing on a same side of the wooden backing as the mirror;
at least one support coupled to the shelf and the wooden backing; and
at least one peg configured for hanging an object,
wherein edges of the wooden backing are beveled, edges of the shelf are beveled, and edges of the at least one support are beveled.

15. A toy chopper comprising:
a wedge having an edge 1/3.2 the width of a base of the wedge, the edge rounded;
the wedge having grooves on at least one side extending from the edge.

16. A faucet extender, comprising:
a flat material having a first hole configured to receive a faucet, the flat material having a second hole configured to receive the faucet, the flat material having a third hole configured to receive the faucet, the faucet extender configured to form a spout when the second hole and the third hole are installed on the faucet.

17. The faucet extender of claim 16, wherein the faucet extender is made from silicone.

18. The faucet extender of claim 16, wherein at least one hole of the first hole, the second hole, and the third hole includes a thickened rim.

19. The faucet extender of claim 16, wherein the first hole is at least 26.0 mm in diameter and includes a 3.0 mm thickened rim.

20. The faucet extender of claim 16, wherein the second hole is at least 16.0 mm in diameter and includes a 3.0 mm thickened rim.
